(19) United States
(12) Patent Application Publication
(10) Pub. No.: US 2011/0193010 A1
(43) Pub. Date: Aug. 11, 2011

(54) THERMALLY CONDUCTIVE ADHESIVE MASS

(75) Inventors: Klaus Keite-Telgenbüscher, Hamburg (DE); Anja Staiger, Hamburg (DE); Florian Meyer, Hameln (DE)

(73) Assignee: TESA SE, Hamburg (DE)

(21) Appl. No.: 12/993,887

(22) PCT Filed: Sep. 23, 2009
(86) PCT No.: PCT/EP2009/062320

§ 371 Date: Nov. 22, 2010

(30) Foreign Application Priority Data
Oct. 1, 2008 (DE) 10 2008 049 850.5

(51) Int. Cl. C09K 5/00

(52) U.S. Cl. 252/76

(57) ABSTRACT

Highly cohesive, thermally conductive adhesive mass, comprising a polymer and aluminum oxide particles, in which more than 95 wt. % of the aluminum oxide particles are alpha aluminum oxide.

The invention relates to a highly cohesive, thermally conducting, pressure-sensitive adhesive with a polymer composition and with aluminum oxide particles, the polymer composition being an at least substantially solvent-free polymer composition with a high molecular mass, acrylate-based base polymer, and to the use of this thermally conducting, pressure-sensitive adhesive for producing a thermally conducting sheetlike element. The invention further relates to a thermally conducting sheetlike element with a thermally conducting, pressure-sensitive adhesive of this kind, and also to the use thereof for thermal transport within electronic devices. The invention relates, finally, to the use of aluminum oxide particles in a pressure-sensitive adhesive, and to a process for preparing the pressure-sensitive adhesive.

In numerous fields of technology a significant role is accorded to the controlled transfer of heat. All fundamental problems in this relate to the transport of thermal energy (heat) from a location of higher temperature (heat source) to a location of lower temperature (heat sink) as a result of a temperature difference (temperature gradient). One possibility for heat transfer is thermal conduction; additionally, heat transfer as part of a convective flow process or else in the form of thermal radiation is also possible.

Examples of typical heat sources are electronic assemblies which produce heat in operation, and also heating elements of any kind, and also vessels within which an exothermic chemical reaction takes place.

Typical heat sinks are cooler elements (such as, for example, passive cooling bodies, cooler/fan combinations, water coolers or Peltier elements) and also any body that is to be heated (for example, iced areas to be thawed, such as roof gutters and surfaces in the automaking segment or in the aerospace travel industry).

One typical problem concerns the diversion of thermal energy which is produced, on the basis of the electrical resistance of components in an electronic circuit, in the form of what is called “Joule heat”. Effective removal of the thermal energy is important particularly for semiconductor assemblies such as integrated circuits where overheating may result in the irreversible destruction of the assembly; frequently employed as heat sinks in this case are the abovementioned cooler elements which are in thermally conducting communication with the assembly (heat source). A thermally conducting connection of this kind is achieved by means of an intermediate layer which is disposed between the heat source and the heat sink and which enhances heat transfer between the heat source and the heat sink, thereby allowing a particularly large thermal flow to be diverted.

Intermediate layers used are generally thermally conductive pastes, which are applied to the surface of the assembly and of the cooler element. These thermally conductive pastes are composed largely of fluid matrix materials, such as of low molecular mass resins or waxes. To increase the thermal conductivity, thermally conducting auxiliaries are added in sufficiently large quantity to these matrix materials. Systems of this kind are usually highly deformable, in order to conform to the surface of the heat source and to the surface of the heat sink, and so to ensure extensive thermal contact with these elements. However, thermally conductive pastes are not capable of compensating mechanical forces that act on them, and so, in addition, a mechanical fixing of the heat sink on the heat source is required.

In order to be able to produce a mechanical connection between heat source and heat sink, in addition to the removal of heat, the use of thermally conducting adhesive systems has emerged as being particularly advantageous. These systems generally comprise mixtures of polymers with additives (known as “polymer compounds”), which are adapted in particular in respect of their thermal conduction properties. The polymer mixtures are typically provided in the form of a fluid adhesive system or pressure-sensitive adhesive system. By means of such polymer mixtures, moreover, it is particularly simple to realize electrical insulation between the heat source and the heat sink, which is an additional requirement for numerous applications especially those in the electronics segment.

Fluid adhesive systems are known, for example, in the form of thermally conducting liquid adhesives or liquid pastes. Liquid adhesives are adhesives which initially are applied to the bond substrate in liquid form and which then cure in situ. For producing the thermally conducting liquid adhesives, conventional polymeric matrix systems which cure chemically (as a result of a crosslinking reaction, for instance) or physically are admixed with auxiliaries that have good thermal conduction.

Disadvantages of such thermally conducting liquid adhesives, however, are that they cannot be metered with sufficient accuracy and that, furthermore, during the joining of heat source with heat sink, they exhibit a flow behavior which cannot be controlled with sufficient precision. As a result of this, the resultant intermediate layers do not have a homogeneous thickness, and, moreover, excess material may emerge at the edges of the bond. A further disadvantage is that the fraction of the thermally conducting auxiliaries as a proportion of the thermally conducting liquid adhesive must be selected to be relatively high, in order to bring about sufficiently good thermal conductivity on the part of the intermediate layer, and this, in turn, greatly lessens the bond strength of the liquid adhesive.

Pressure-sensitive adhesive systems are known, for example, in the form of double-sidedly bondable sticky labels, in the form of an adhesive pad or adhesive tape, for instance. These systems feature a substantially two-dimensional disposition comprising at least one pressure-sensitive adhesive, and may be designed with a permanent carrier or else in carrier-free form. Where pressure-sensitive adhesive systems are used, it is possible to obtain defined intermediate layers which, by virtue of their bond strength to the respective substrate, are able to transfer and divert mechanical forces that act on said substrate, without being damaged in the process. If, however, a particularly high thermal conductivity is to be realized, then, in the case of pressure-sensitive adhesive systems as well, this is achieved by selecting a high fraction of thermally conducting auxiliaries in the pressure-sensitive adhesive system, and this, in turn, results in a reduction in the bond strength and in the internal holding-together (cohesion) of the pressure-sensitive adhesive system.

The reduction in cohesion is even more problematic, however, when the pressure-sensitive adhesive system, as well as having good thermal conductivity, is to be electrically insulating. In this case, the auxiliaries with particularly good thermal conduction that comprise metals such as silver, gold, aluminum or copper, for instance, cannot be consistently used, and instead it is necessary to switch to nonmetallic thermally conducting materials. Nonmetallic materials, however, generally have a considerably lower thermal conductivity than metallic materials, and so, when using nonmetallic materials, the fraction of auxiliaries may have to be even greater if the intention overall is to achieve a level of thermal conductivity on the part of the pressure-sensitive adhesive system that is comparable with the thermal conductivity of metallic materials.

Nonmetallic thermally conducting auxiliaries employed include, in particular, aluminum oxide (Al₂O₃) and boron nitride (BN). The former in particular is preferred on account of its ready availability and on account of the favorable tradeoff between costs and attainable thermal conductivity. As typical nonmetallic auxiliaries it is also possible, for example, to use silicon dioxide (SiO₂), titanium(VI) boride (TiB₂), silicon nitride (Si₂N₄), titanium dioxide (TiO₂), magnesium oxide (MgO), nickel(II) oxide (NiO), copper(II) oxide (CuO), and iron(III) oxide (Fe₂O₂). Moreover, a large number of other nonmetallic materials are used as thermal conduction auxiliaries, examples being ZrO₂(MgO), ZrO₂(Y₂O₂), aluminum titanate (Al₂TiO₅), aluminum nitride (AlN), boron carbide (B₄C), cordierite, reaction-bonded, silicon-infiltrated silicon carbide (SiSiC), non-pressure-sintered silicon carbide (SSiC), hot-pressed silicon carbide (HPSiC), hot-isostatically pressed silicon carbide (HIPSiC), reaction-bonded silicon nitride (RBSN), non-pressure-sintered silicon nitride (SSN), hot-pressed silicon nitride (HPSN) or hot-isostatically pressed silicon nitride (HIPSN).

As a polymeric matrix system of a pressure-sensitive adhesive system (i.e., as its high molecular mass constituents), EP 0 566 093 A1, EP 0 942 059 B1, and EP 0 942 060 B1 disclose, inter alia, pressure-sensitive adhesives which are based on esters of acrylic acid or methacrylic acid. Pressure-sensitive adhesives of this kind are notable for particularly high thermal stability and aging stability. In order to realize a high bond strength (more particularly a high shear strength), the pressure-sensitive adhesives contain comonomers having free acid groups, examples being acrylic acid or methacrylic acid.

In order to produce a thermally conducting mixture from a polymeric matrix system of this kind, the polymers of the pressure-sensitive adhesive system are blended (compounded) with the thermally conducting auxiliary, and then, where appropriate, are applied to the substrate or to a permanent or temporary carrier. Blending and applying may take place in principle in the melt, in solution or in dispersion.

In the case of blending in solution, the polymeric matrix system is dissolved wholly or at least partly in a suitable liquid medium, the solvent (the term “solvent” is used here in a functional sense and therefore encompasses not only the actual solvents (for example, water, volatile organic compounds, known as “VOCs”) but also polymerized monomers in which the polymers are soluble, and dispersion media).

The auxiliary is subsequently introduced with stirring into the resultant solution. Lastly, the solvent is removed from the mixture, which ought usually to be done completely as far as possible, in order to prevent formation of bubbles in the end product which might otherwise occur during evaporation of the solvent. Similar to this is blending in dispersion, where the polymeric matrix system is not dissolved in the solvent as dispersion medium, but instead merely suspended.

Where, however, when blending in solution, an auxiliary is used which is not itself soluble in the solvent, and whose density is greater than the density of the solution, then gravity means that the auxiliary settles in the course of blending. On the basis of this sedimentation, therefore, the mixture following removal of the solvent has an uneven distribution of the auxiliary in the polymer matrix.

Such inhomogeneity on the part of the thermally conducting mixture can be avoided if blending takes place at elevated temperatures in the melt. The mixing temperature in this case is selected such that it is in the vicinity of, or is higher than, the softening temperature of at least part of the polymeric matrix system. Under such conditions, the polymeric matrix system possesses a significantly lower viscosity than at room temperature (thermoplastic behavior), and so mechanical mixing with the added auxiliary is possible, in a compounder or an extruder, for instance.

Since no solvent is added (or such solvent is employed in a small amount at most) in the course of such blending in the melt, it is also not necessary in this case to remove any solvent subsequently from the adhesive. Since, therefore, there is also no solvent present in the adhesive in a later process step, and no solvent is able to evaporate there, the formation in the end product of bubbles, which might occur in the case, for instance, of evaporation of the solvent during application, is avoided. It is therefore possible, in the case of blending and application from the melt, to obtain homogeneous coatings within a short time even when the adhesive is applied at a high film thickness.

Even in the case of blending and application from the melt, however, problems may occur that make homogeneous coating more difficult or even prevent it entirely. As described for the second comparative example from EP 0 942 060 B1, it is possible with certain polymers for unwanted crosslinking (gel-forming, gelling) to occur in the course of the preparation of thermally conducting mixtures, such crosslinking resulting in a sharp increase in viscosity and being particularly problematic in the case of blending in the melt. It is true that gelling may also occur during blending in solution, but such gelling can be counteracted at least in part through the choice of suitable polymer concentrations in the solution. For blending in the melt, in contrast, this phenomenon is particularly critical, on account of the considerably higher viscosity of the mixture that is the case anyway with this method, for the reason that, owing to the in some cases extremely sharp increase in viscosity as a consequence of gelling, further processing of the mixture is made more difficult or is even prevented entirely, and so, with such compositions, it is not possible to produce a sticky label from the melt.

The problem of gelling occurs in particular when aluminum oxide is added to a melted polymer, and a rapidly progressing crosslinking of the polymer is observed during blending. When aluminum oxide is used as a thermally conducting auxiliary, therefore, it is generally not possible to blend the adhesive in the melt and/or to apply it from the melt, and so a switch must be made to other thermally conducting auxiliaries; these alternative auxiliaries, however, are frequently disadvantageous on both economic and environmental grounds.

It is an object of the present invention, therefore, to provide a highly cohesive, thermally conducting, pressure-sensitive adhesive which has good thermal conduction and at the same time is electrically insulating, and which eliminates these disadvantages, offering more particularly a good and durable thermal contact with the surface of a heat source and/or heat sink, and which, furthermore, is easy to process.

This object is surprisingly achieved by a highly cohesive, thermally conducting, pressure-sensitive adhesive of the type specified at the outset, in which the aluminum oxide particles are composed in a fraction of more than 95% by weight of alpha-aluminum oxide, more particularly in a fraction of 97% by weight or more. In experiments it has been found that, even at high temperatures, gelling of the polymer matrix can be efficiently prevented if aluminum oxide is used that is composed almost entirely of alpha-aluminum oxide (rhombohedral or trigonal aluminum oxide; in the form of corundum, for instance) and that has only a very small fraction of other modifications, for instance cubic gamma-aluminum oxide (active alumina), amorphous aluminum oxide or else, possibly, the merely so-called “beta-aluminum oxide” (Na₂O*11Al₂O₃). Even with aluminum oxide particles that contain just 95% by weight of alpha-aluminum oxide, gelling or crosslinking of the polymer during actual incorporation of the aluminum oxide particles into the melt was observed, meaning that the resultant adhesive could no longer be shaped or applied as a homogeneous layer.

On the basis of the results from the experimental investigations it is thought that the effect according to the invention derives from a lower level of interaction of alpha-aluminum oxide, in relation to beta-aluminum oxide and gamma-aluminum oxide, with the polymeric phase, meaning that there is no formation of a superordinate network of a plurality of polymer molecules. With a mass fraction of gamma-aluminum oxide (and/or, possibly, of beta-aluminum oxide) of less than 5% by weight, based on the total mass of the aluminum oxide particles (corresponding to an alpha-aluminum oxide content of more than 95% by weight), it is not possible for a network to form that percolates throughout the volume of the adhesive, and hence complete gelling is prevented.

In this way it is possible to prevent premature crosslinking or gelling, within the thermally conducting pressure-sensitive adhesive, of polymer components based on acrylic acid or methacrylic acid or their esters; such premature crosslinking or gelling may occur in the mixing assembly itself, and results in a sharp increase in the viscosity. When a high fraction of alpha-aluminum oxide is taken into account, the resultant mixtures also continue to retain outstanding processing properties.

In this context there are certain adhesive systems where the problem of viscosity increase is particularly great, since in these systems the gelling of the polymer matrix is especially easy. For this reason, for readily gelling adhesives of this kind, the application of the inventive concept has emerged as being particularly advantageous.

For instance, subsequent gelling is a problem especially with polymers which contain free acid groups or free hydroxyl groups, since in such polymers the interaction with the aluminum oxide is particularly great. The advantageous effect of the present invention, therefore, is also particularly great in the case of these systems.

Gelling frequently occurs when the polymer composition is composed of monomer units which are at least weakly acidic, examples being acrylates, methacrylates, their esters, and derivatives thereof, especially when these monomer units are present in the polymer composition in a high fraction of at least 50% by weight, based on the mass of the polymeric fractions of the adhesive. Polymer compositions of this kind are employed principally when the aim is to produce adhesives having a particularly high viscosity. Accordingly, the inventive concept is also particularly favorable in respect of highly cohesive adhesives with compositions of this kind.

Rapid gelling also occurs when the base polymer of the polymer composition has a high average molecular mass M_{w} of at least 500 000 g/mol, more particularly of more than 1 000 000 g/mol, and so the present invention is likewise particularly meaningful in the case of adhesives of this kind.

It is particularly useful in this context if the aluminum oxide particles are present in the highly cohesive, thermally conducting, pressure-sensitive adhesive in a fraction of at least 20% by weight and not more than 90%, based on the mass of the aluminum oxide particles in the pressure-sensitive adhesive. This ensures that the pressure-sensitive adhesive exhibits a sufficient bond strength in conjunction with high internal cohesion and good thermal conductivity. In this case, an amount of 40% by weight to 80% by weight represents a particularly good tradeoff, thus offering rapid heat transport in conjunction with good bonding performance. This can be attributed on the one hand to the high thermal conductivity of thermally conducting pressure-sensitive adhesives of this kind, but also, on the other hand, to a sufficiently high internal cohesion of the polymer matrix under these conditions, which offers reliable thermal contact to the surfaces of the heat source and the heat sink even under mechanical load.

In addition, however, such highly cohesive, thermally conducting, pressure-sensitive adhesives may also be advantageous when they contain aluminum oxide particles in a fraction of at least 20% by weight and not more than 40% by weight, in other words when pressure-sensitive adhesives with particularly high bonding performance are to be produced, or when they contain aluminum oxide particles in a fraction of at least 80% by weight and not more than 90% by weight, in other words when particularly high thermal conductivity is required.

It is particularly favorable, furthermore, if the aluminum oxide particles have a mass-based specific surface area of not more than 1.3 m²/g, preferably of less than 1.0 m²/g. In the case of such particulate auxiliaries with specific surface areas of less than 1.3 m²/g, in particular, it has been observed that they result in a significantly higher thermal conductivity in the pressure-sensitive adhesive than particulate auxiliaries of the same material but having a higher specific surface area. Accordingly, when using such particles, it is possible to realize overall a high thermal conductivity in the pressure-sensitive adhesive even with a small amount of aluminum oxide. As a result, the pressure-sensitive adhesive may possess a higher polymer fraction and hence exhibit better cohesion and also better adhesion.

For the cohesion of the adhesive it is of advantage, in particular, if the aluminum oxide particles are composed additionally of primary particles. In this case the aluminum oxide particles have an irregularly shaped surface, which is not smooth. As a result, the polymeric phase is able to penetrate at least partly into the aluminum oxide particles, thus producing a particularly high internal cohesion on the part of the adhesive. For reasons of pore geometry, it is especially advantageous in this context if the primary particles have an average diameter of at least 1 μm or even of at least 2 μm, since, in this way, pressure-sensitive adhesives are obtained that have good thermal conduction and whose cohesion is still high enough, even at high temperatures at which the viscosity of the polymer matrix reduces, to ensure, overall, a stable cohesion.

It is advantageous, moreover, if the particles have an average diameter from a range from 2 μm to 500 μm, more particularly from a range from 2 μm to 200 μm, or even from a range from 40 μm to 150 μm. As a result of this design of the aluminum oxide, the thermal contact with the heat source and the heat sink is in fact improved still further, since the particles on the one hand are sufficiently small to conform precisely to the shape of the surface of the heat source and the heat sink, but on the other hand are sufficiently large to attain a high thermal conductivity without adversely affecting, overall, the internal cohesion of the pressure-sensitive adhesive.

From the prior art it is known, furthermore, that for conventional pressure-sensitive adhesives it is unfavorable if a polymer composition is used which is coated from the melt and has a solvent content of less than 0.1% by weight. In the case of such polymer compositions, the viscosity is already relatively high even without additional gelling, and so a further increase in viscosity due to gelling may then prevent processing of the adhesive even when the extent of this additional gelling is only small. Consequently, even with low-solvent systems of this kind, the inventive use of particles consisting predominantly of alpha-aluminum oxide is a definite advantage.

A low-solvent pressure-sensitive adhesive of this kind offers the advantage that it can be applied in layer form without formation of disruptive bubbles in the adhesive at the same time. In the case of pressure-sensitive adhesives blended and/or applied in solution, bubble formation occurs regularly during evaporation of the residual solvent, thereby not only impairing the visual appearance but also reducing the area that is available effectively for heat transport, and, moreover, lessening the cohesion and adhesion of the adhesive.

A further favorable application of the inventive concept relates to the above-described highly cohesive, thermally conducting, pressure-sensitive adhesive which is obtainable in a process wherein the at least substantially solvent-free polymer composition is thermally softened without addition of solvent, the aluminum oxide particles are added to the softened polymer composition, and the softened polymer composition and the aluminum oxide particles are combined with one another mechanically. A pressure-sensitive adhesive obtainable in this way has a particularly low solvent content, with the advantages described above.

Where this process results in the above, particularly low-solvent-content pressure-sensitive adhesive, then it is also advantageous, in a process for preparing a highly cohesive, thermally conducting, pressure-sensitive adhesive, if an at least substantially solvent-free polymer composition comprising a high molecular mass, acrylate-based base polymer is thermally softened without addition of solvent, aluminum oxide particles with a fraction of alpha-aluminum oxide of more than 95% by weight (based on the mass of the aluminum oxide particles) are added to the softened polymer composition, and the softened polymer composition is combined mechanically with the aluminum oxide particles.

The present invention further provides for the use of aluminum oxide particles composed in a fraction of more than 95% by weight of alpha-aluminum oxide in a pressure-sensitive adhesive. Only this use makes it possible to prepare low-solvent-content pressure-sensitive adhesives having a high level of aluminum oxide as thermally conducting auxiliary, with which high cohesion and adhesion as well can be achieved at the same time as good thermal conductivity.

In accordance with a further aspect of the present invention, a thermally conducting sheetlike element is provided that comprises a highly cohesive, thermally conducting, pressure-sensitive adhesive having the composition described above. By means of this thermally conducting sheetlike element, an intermediate layer can be introduced in a particularly simple way between a heat source and a heat sink, this intermediate layer efficiently diverting the heat that is produced in the heat source and reliably working it at the same time. Correspondingly, the present invention further provides for the use of the above pressure-sensitive adhesive for producing a thermally conducting sheetlike element, thereby making it possible in a particularly simple way to produce a thermally conducting sheetlike element which can be joined, without problems and without the need for further fixing means, to the surfaces of heat sources and heat sinks, where it offers a stable bond.

Lastly, the use is proposed of the above highly cohesive, thermally conducting, pressure-sensitive adhesive for heat transport within electronic devices, whereby the high reliability of this pressure-sensitive adhesive and also the outstanding thermal contact achievable with it between the heat source and the heat sink efficiently counteract damage to the components of the electronic device as a result of local overheating.

The present invention accordingly provides, generally speaking, pressure-sensitive adhesives (PSAs). PSAs is the term for those adhesives which permit permanent bonding to the substrate at room temperature under just a relatively weak applied pressure. The bondability of PSAs derives from the adhesive properties, among others, of the respective adhesive.

Adhesion typically refers to the physical effect brought about by the holding-together of two phases, brought into contact with one another, at their interface on account of intermolecular interactions that occur there. Adhesion therefore defines the attachment of the adhesive to the substrate surface and can be determined as tack or as bond strength. In order to influence the adhesion of an adhesive in a specific way, it is common to add plasticizers and/or bond-strength enhancer resins (known as “tackifiers”) to the adhesive.

Cohesion typically refers to the physical effect which results in the internal holding-together of a substance or composition on account of intermolecular and/or intramolecular interactions. The forces of cohesion therefore determine the consistency and fluidity of the adhesive, which can be determined, for instance, as viscosity and as shear resistance time. In order to increase the cohesion of an adhesive in a specific way, it is often subjected to additional crosslinking, for which reactive (and hence crosslinkable) constituents or other chemical crosslinkers are added to the adhesive and/or the adhesive is subjected to actinic (high-energy) radiation, as for example ultraviolet light or electron beams, in an aftertreatment.

The technical properties of a PSA are determined primarily by the relationship between adhesional and cohesional properties. For certain applications, for example, it is important that the adhesives used are highly cohesive, i.e., possess a particularly strong internal holding-together, whereas for other applications a particularly high adhesion is required. PSAs may additionally be equipped with chemical or physical curing or crosslinking mechanisms.

A highly cohesive PSA is any PSA which has a high viscosity even without aftercrosslinking—in other words, in the noncrosslinked state. High viscosity is considered in particular to be a complex viscosity of more than 200 Pa*s or, very particularly, of more than 1000 Pa*s, and, in the strict sense, only a viscosity of more than 10 000 Pa*s (determined in each case with a rotary viscometer at 10 rad/s and 110° C.). Of course, this does not rule out the subjection of a high-viscosity adhesive of this kind, following application to a substrate or a carrier, to a concluding aftercrosslinking reaction additionally, in order to increase further the viscosity which is already high from the outset.

A thermally conducting PSA for the purposes of the present invention is any desired, suitable PSA which has a high thermal conductivity. The thermal conductivity of a substance is determined by the rate at which local heating of the substance propagates through the substance, and it therefore corresponds to the capacity of the substance to transport thermal energy by means of conduction in the form of heat. Thermal conductivity is typically quantified as a temperature-dependent material constant, i.e., as (specific) thermal conductivity or coefficient of thermal conductivity, which is assigned the formula symbol λ (lambda), l, k or κ (kappa) and the unit W/(K·m). A high thermal conductivity is considered more particularly to be a thermal conductivity higher than the thermal conductivity of the 60/40 water/ethylene glycol mixtures that are commonly used as heat-transfer media (thermal transport agents) in the energy industry, in other words which at 25° C. is greater than 0.44 W/mK.

This composition ought further to have properties which are constant over time during use as a PSA, and ought therefore to be inert under the specific application conditions (particularly in the temperature range of the application), so that no unintended chemical decomposition processes take place to any notable extent in the composition. However, this does not rule out the possibility of gradual, long-term breakdown of the composition in a PSA, as a result of usual service, of the kind that occurs with the known fluid heat transport systems as well, for instance. Furthermore, in a PSA of the invention, there may also be a deliberate chemical change, such as an aftercrosslinking which is carried out to boost cohesion after the PSA has been applied to the surface of a carrier, the heat source or the heat sink, and also an intended phase transition within the PSA for the purpose of obtaining latent heat storage.

In accordance with the invention, the highly cohesive, thermally conducting, pressure-sensitive adhesive comprises at least aluminum oxide particles as thermally conducting auxiliary, and a polymer composition. Where the polymer composition comprises a high molecular mass, acrylate-based base polymer, polymer compositions which can be used include, without exception, all polymers that are suitable and are known to the skilled person, and also mixtures of these polymers with one another and/or with further auxiliaries, which are chemically stable within the particular field of application. These include not only low molecular mass polymeric waxes and resins but also high molecular mass polymer compositions and technical polymers. These include, for example, polymers based on natural rubbers, synthetic rubbers and/or silicones, and more particularly polymers based on acrylates and/or methacrylates.

In order to prevent bubbles on application in layer form, or in the course of a subsequent application, this polymer composition must be at least substantially solvent-free. By an at least substantially solvent-free polymer composition is meant a polymer composition which has a low molecular mass solvent (VOC) content of less than 0.5% by weight, or even of less than 0.1% by weight. An at least substantially solvent-free polymer composition ought, furthermore, to possess a solvent content of not more than 5% by weight throughout the entire process of blending and application. An even lower content gives even better results in the context of bubble-free application, but in practice is frequently unrealizable, since many polymers, and especially certain acrylates, can only be prepared in solution and hence cannot be used technically in an entirely solvent-free form, but only as substantially solvent-free polymers.

With a view to the prevention of bubbles it is especially advantageous if not merely the polymer composition is of at least substantially solvent-free form, but instead if, furthermore, the highly cohesive, thermally conducting, pressure-sensitive adhesive overall has at most an extremely low solvent content (volatile organic compounds, water and the like), in particular of less than 0.05% by weight or even of less than 0.01% by weight, based on the total weight of the pressure-sensitive adhesive; an at least substantially solvent-free PSA of this kind with aluminum oxide particles is obtainable when the teaching according to the invention is applied.

The polymer composition comprises a high molecular mass, acrylate-based base polymer. The base polymer of a polymer mixture is a polymer whose properties dominate certain or even all of the properties of the polymer mixture as a whole; this, of course, does not rule out the additional influencing of the properties of the polymer composition through use of modifying auxiliaries or additives or of further polymers in the composition. This may mean in particular that the fraction of the base polymer as a proportion of the total mass of the polymeric phase is more than 50% by weight. Where the polymer composition contains only a single polymer, that polymer is of course the base polymer.

In accordance with the invention, the base polymer must itself be of high molecular mass, in other words have a molecular mass (molar mass) of more than 100 000 g/mol (corresponding to an average molecule mass of at least 100 kD). The base polymer preferably has a molecular mass of at least 500 000 g/mol, more preferably of more than 1 000 000 g/mol. The molecular mass used in connection with these polymers is understood presently to be the weight average, M_{w}, of the molecular mass.

The base polymer here is an acrylate-based polymer. This means that the base polymer of the polymer composition is composed to an extent of more than 50% of monomer units (based on the number of monomer units present in the base polymer) whose chemical structure can be derived from the structure of acrylic acid—that is, for instance, acrylic acid, methacrylic acid or their substituted or unsubstituted derivatives. Advantageously not only the base polymer of the polymer composition but also the entire polymer composition itself is composed predominantly—that is, to an extent of 50% by weight or more—of monomer units which derive from acrylic acid, in other words of acrylates, methacrylates, their esters, and derivatives thereof.

For the purposes of this invention, then, polymers based on acrylic acid and/or methacrylic acid can be used, examples being those based on acrylic esters, methacrylic esters and/or derivatives thereof, since these compounds have particular aging stability and are therefore able to withstand repeated heat transport processes over a long time. Particularly suitable are acrylate-based polymers which are obtainable, for instance, by radical polymerization and which are based at least partly on at least one acrylic monomer of general formula CH₂═C(R¹)(COOR²), where R¹ is H or a CH₃ radical and R² is selected from the group of saturated, unbranched or branched, substituted or unsubstituted C₁ to C₃₀ alkyl radicals (advantageously the C₂ to C₂₀ alkyl radicals, the C₄ to C₂₄ alkyl radicals or even the C₄ to C₉ alkyl radicals), but may optionally also represent H.

Specific examples, without wishing to be restricted by this recitation, are methyl acrylate, methyl methacrylate, ethyl acrylate, n-butyl acrylate, n-butyl methacrylate, n-pentyl acrylate, n-hexyl acrylate, n-heptyl acrylate, n-octyl acrylate, n-octyl metharylate, n-nonyl acrylate, lauryl acrylate, stearyl acrylate, behenyl acrylate and their branched isomers, examples being isobutyl acrylate, 2-ethylhexyl acrylate, 2-ethylhexyl methacrylate, isooctyl acrylate, isooctyl methacrylate, cyclohexyl methacrylate, isobornyl acrylate, isobornyl methacrylate, and 3,5-dimethyladamantyl acrylate.

The base polymer may further comprise monomer units having free acid groups and/or free hydroxyl groups, since these allow particularly high cohesion to be achieved. Free acid groups contemplated include all groups which act as Lewis acids. This also includes those groups which themselves constitute Brönsted acids, in other words from which protons can be eliminated. These may be, for example, carboxyl groups (—COOH), sulfonic acid groups (—SO₃H), phosphonate groups (—PO₃HR, where R is H or an organic radical), phosphoric ester groups (—OPO₃HR, where R is H or an organic radical), sulfuric ester groups (—OSO₃H), boric ester groups (—OBO₃HR, where R is H or an organic radical), carbonic ester groups (—OCO₂H), or the corresponding thio compounds of the above groups. As examples of monomers of this kind, mention may be made, for instance, of acrylic acid, methacrylic acid, and also hydroxyethyl methacrylates, without restriction through the exemplary recitation.

In addition to the at least one type of acrylic monomer, these polymers may include further comonomers, which advantageously are polymerizable with the at least one acrylic monomer, such as for instance vinyl compounds having functional groups, maleic anhydride, styrene, styrenic compounds, vinyl acetate, acrylamides, double-bond-functionalized photo-initiators, and the like.

In accordance with the invention, the polymer composition serves as a matrix for aluminum oxide particles which are used as thermally conducting auxiliary. An auxiliary (adjuvant, additive) is understood in principle to be any substance which is added to the polymer constituents (the polymeric phase, polymer matrix) of the PSA in order to exert a deliberate influence over the properties and functionality of the PSA. A thermally conducting auxiliary is any auxiliary which itself has a high thermal conductivity and, when incorporated into a polymer matrix, increases the thermal conductivity of the mixture overall.

The mass fraction of the aluminum oxide particles in the PSA may be advantageously at least 20% by weight and not more than 90% by weight, more particularly at least 40% by weight and not more than 80% by weight.

Thermally conducting auxiliaries which can be used are, in general, all particulate aluminum oxides (Al₂O₃) which can be mixed with the polymer. Essential to the invention in this context is that the fraction of the alpha-aluminum oxide in the aluminum oxide particles is more than 95% by weight or even more than 97% by weight. Accordingly, the fraction of other aluminum oxide modifications (that is, for instance, gamma-aluminum oxide or amorphous aluminum oxide, and possibly also—without being an aluminum oxide in chemical terms—beta-aluminum oxide) must therefore be less than 5% by weight, or, even, less than 3% by weight.

In accordance with the present invention, the aluminum oxide is in the form of particles. Particles are considered presently to comprehend any accumulation of material that is composed of individual volume bodies delimited from one another and with external dimensions that are very small—in other words, for example, powders, dusts, including fine dusts, colloids, including sols, aerosols, and the like. The definition of a particle does not depend fundamentally on the particle having a particular internal structure, a particular crystallinity, a particular form factor or a particular—regular or irregular—external shape. However, in accordance with the invention, it is necessary for a total of more than 95% by weight of the aluminum oxide particles to consist of alpha-aluminum oxide.

With a view to confining the external dimensions of these particles, it may be useful if only those particles are employed that have an average diameter from a range from 2 μm to 500 μm, more particularly from a range from 2 μm to 200 μm, or even from a range from 40 μm to 150 μm. Average diameter means a particle diameter averaged via a particle size distribution, as a mass average or number average, and this particle diameter may be identical to the single particle size in the case where there is only one single particle size (i.e., a monodisperse substance). Instead of this, the average particle diameter may also be defined as the D50 value, in other words as that particle diameter above which and below which 50% by weight of the particles within the size distribution are located. The particle diameter used here is the average diameter averaged via a particle, which in the case of irregularly shaped particles lies between the maximum diameter and the minimum diameter of the particles.

Particle sizes and their distributions can be determined using all of the methods that are customary for the purpose, as for instance by means of image analysis on microscopic images (for example, images obtained from optical microscopy, including ultramicroscopy, from electron microscopy or from scanning force microscopy), from the diffraction or scattering of electromagnetic radiation (for instance, laser diffraction or scattering, or X-ray diffraction/scattering, including small-angle scattering), from sedimentation measurements, as for instance by means of an ultracentrifuge, and the like.

The aluminum oxide particles may be in any desired form, for instance as compact particles or porous. For particularly good thermal conductivity, however, it may be advantageous if the particles have a mass-based specific surface area of 1.3 m²/g or less, preferably even of less than 1.0 m²/g. The specific surface area of the particles is the entirety of all of the surfaces that are present within the sample volume, including not merely the outer boundary of the particles (external surface area or geometric surface area, which is therefore visible from the outside), but likewise the surface area within the particles, as for instance the boundary surfaces within individual cavities, channels, pores, and the like. Designated in the present case is the mass-base specific surface area of the particles, in other words the surface area present in a sample amount of a mass of 1 g. Typically, such specific surface areas are determined by means of the sorption method (BET determination), in which the adsorption and desorption of a probe gas (generally nitrogen, helium or mercury) at the available surface area of the sample are investigated.

Furthermore, it may be useful to use particles which in turn are composed of primary particles. A primary particle is a particle of very small diameter which, for example, is almost wholly crystalline (crystallite) or amorphous, and of which, in turn, larger structures are composed, in the present case the particles. These particles may be polycrystalline (for instance, when the primary particles as individual crystal domains have a different spatial orientation) or else may possess a superordinate crystal structure.

Particles composed of primary particles may be present in the form of any desired three-dimensional accumulation of a large number of smaller individuals that are crowded closely to one another and joined externally—in the form, for example, of a nonfused assembly of primary particles adjoining one another at edges and angles, and with a total surface area virtually identical to the sum of the individual surface areas, or as a fused assembly of primary particles adjoining flatly with one another via side-face regions, with a surface area smaller than the sum of the surface areas of the primary particles—in the form, for instance, therefore, of agglomerates, aggregates, associations, coacervates, flocculates, conglomerates, and the like.

These primary particles may optionally have average diameters of at least 1 μm, more particularly of at least 2 μm. Corresponding to the particle diameter, the average diameter is understood to be a primary particle diameter averaged via a primary particle size distribution, as mass average or number average. The primary particle diameter is the average diameter, averaged over individual primary particles, which in the case of irregularly shaped primary particles, for instance, lies between the maximum diameter and the minimum diameter of the primary particles.

If the primary particles have the size described above, then the adjoining of the primary particles produces hollow-space structures (pores) between the primary particles. These pores are very large, and so the polymer matrix may penetrate at least partly into the particles, by filling part of the space between two adjacent primary particles. Complete coverage of the surface area present within particles, however, even under these conditions, is unlikely, since with small pore diameters in particular the capillary pressure within these pores may be very high, and so within the particles there may also be sections of the particle surface area that are not covered by the polymer composition and are therefore exposed.

A thermally conducting PSA may of course, furthermore, also include other formulating constituents and/or adjuvants such as, for example, auxiliaries, pigments, rheological additives, adhesion promoter additives, plasticizers, resins, elastomers, aging inhibitors (antioxidants), light stabilizers, UV absorbers, and also other auxiliaries and additives, examples being driers (for instance molecular sieve zeolites or calcium oxide), flow and flow-control agents, wetting agents such as surfactants or catalysts, other thermally conducting fillers, and also heat-storing fillers.

Auxiliaries used may be all finely ground, solid adjuvants, examples being chalk, magnesium carbonate, zinc carbonate, kaolin, barium sulfate, titanium dioxide or calcium oxide. Other examples are talc, mica, silica, silicates or zinc oxide. Of course, mixtures of the substances stated may also be used.

The pigments used may be organic or inorganic in nature. All kinds of organic or inorganic color pigments are contemplated, examples being white pigments such as titanium dioxide (for improving the light stability and UV stability) or metal pigments. Where metal pigments or other metallic auxiliaries or carrier materials are used, it should of course be ensured that these metallic constituents, when employed in a thermally conducting sheetlike element that is electrically insulating overall and has a high electrical breakdown resistance, must not be present comprehensively throughout the thickness of the sheetlike element; instead, the sheetlike element, at least in one laminar subregion, must be completely electrically insulating.

Examples of rheological additives are fumed silicas, phyllosilicates (bentonites, for example), high molecular mass polyamide powders, or powders based on castor oil derivatives.

Adhesion promoter additives may be, for example, substances from the groups of the polyamides, epoxides or silanes. The improvement in adhesion that can be achieved using such promoters relates not only to the adhesion of the PSA to a bond substrate or carrier, but also to the internal adhesion of the polymer matrix to the aluminum oxide particles.

Examples of plasticizers for improving the adhesiveness are phthalic esters, trimellitic esters, phosphoric esters, adipic esters, and esters of other acyclic dicarboxylic acids, fatty acid esters, hydroxycarboxylic esters, alkylsulfonic esters of phenol, aliphatic, cycloaliphatic, and aromatic mineral oils, hydrocarbons, liquid or semisolid rubbers (for example, nitrile rubbers or polyisoprene rubbers), liquid or semisolid polymers of butene and/or isobutene, acrylic esters, polyvinyl ethers, liquid resins and plasticizing resins based on the raw materials which also constitute the basis for tackifying resins, lanolin and other waxes, silicones, and also polymer plasticizers such as polyesters or polyurethanes, for instance.

Formulating the highly cohesive, thermally conducting, pressure-sensitive adhesive with the further constituents, such as auxiliaries and plasticizers, for example, is likewise prior art.

In order to optimize the technical adhesive properties, the PSAs of the invention may be admixed with resins. Tackifying resins (bond strength enhancer resins) for addition that can be used include, without exception, all existing tackifier resins described in the literature. Representatives that may be mentioned include the pinene resins, indene resins, and rosins, their disproportionated, hydrogenated, polymerized, and esterified derivatives and salts, the aliphatic and aromatic hydrocarbon resins, terpene resins and terpene-phenolic resins, and also C₅ to C₉ and other hydrocarbon resins. Any desired combinations of these and additional resins may be used in order to bring the properties of the resultant PSA into line with requirements. Generally speaking, it is possible to use all resins that are compatible (soluble) with the corresponding base polymer; reference may be made in particular to all aliphatic, aromatic, and alkylaromatic hydrocarbon resins, hydrocarbon resins based on pure monomers, hydrogenated hydrocarbon resins, functional hydrocarbon resins, and natural resins.

A further advantageous embodiment of the sheetlike element may be achieved by adding a heat-storing filler to at least one of the layers. A heat-storing filler in the present context means any filler having a high heat capacity, more particularly having a heat capacity of more than 0.7 J/gK. As a result of the thermal buffer effect of such substances, uniform heat transport can be obtained in this way. Fillers with high heat capacity that can be used advantageously are, for instance, aluminum, boron, calcium, iron, graphite, copper, magnesium or compounds of the aforementioned substances, especially aluminum chloride, calcium carbonate, calcium chloride, copper sulfate, magnetite, hematite, magnesium carbonate, and magnesium chloride.

As heat-storing filler it is preferred to use a phase-transition or “phase change” material. With the aid of these materials it is possible to buffer short-term peaks in the thermal flux. Latent heat stores of this kind that can be used include all of the phase change materials that are known to the skilled person, examples being low-melting salts or paraffin waxes.

The PSAs of the invention can be used with outstanding effect for producing a thermally conducting sheetlike element. Sheetlike elements for the purposes of this specification are, in particular, all customary and suitable structures having a substantially two-dimensional extent. These structures may take various forms, being flexible in particular, as a sheet, tape, label or shaped diecut. The sheetlike elements thus obtained may be of any desired type—that is, they may, for instance, have a permanent carrier or else may be of carrier-free design.

The PSA of the invention can be prepared using, without exception, all known and suitable methods, preferably not carried out in the presence of solvent. Thus, for example, the at least one polymer may be mixed with the filler or fillers in a typical mixing assembly, as a solid or in the melt, such as in a compounder or twin-screw extruder, for instance.

The sheetlike elements of the invention as well can be produced using, without exception, all known and suitable methods. Hence sheetlike arrangements of the thermally conducting PSA of the sheetlike element of the invention can be produced with the familiar techniques for producing polymeric sheetlike elements in accordance with the prior art. These include, for instance, flat-film extrusion, blown-film extrusion, the calendar process, and coating from the melt or from a monomeric or prepolymeric precursor of the polymer.

A process for preparing a highly cohesive, thermally conducting, pressure-sensitive adhesive therefore comprises, for example, the following three steps, namely the first step, in which an at least substantially solvent-free polymer composition comprising a high molecular mass, acrylate-based base polymer is thermally softened without addition of solvent, the second step, in which aluminum oxide particles with a fraction of alpha-aluminum oxide of more than 95% by weight are added to the softened polymer composition, and the third step, in which the softened polymer composition and the aluminum oxide particles are combined mechanically with one another, with all three steps being carried out without use of solvents. In this way it is possible to obtain a highly cohesive PSA which has a particularly low solvent content.

For producing the sheetlike elements it is possible, for example, first of all to spread out the highly cohesive, thermally conducting, pressure-sensitive adhesive in the form of a layer, as for instance on a permanent carrier or on a temporary production carrier (known as an “in-process liner”), which is separated from the sheetlike element again during the process, or no later than at the end of the process. Where a permanent carrier is used, it is advantageous if it too possesses a high thermal conductivity, by virtue, for instance, of likewise comprising thermally conducting fillers. Alternatively or additionally the sheetlike element, as a thermally conducting carrier by means of which rapid heat transport is realized likewise over the entire area of the sheetlike element, may comprise a sheetlike metallic structure, such as, for example, a foil, a lattice, a nonwoven web, a woven fabric or an expanded metal. Sheetlike elements with constructions of this kind are used in accordance with the invention for connecting heat sources and heat sinks, particularly within electronic devices.

Further advantages and possibilities for application will become apparent from the working examples, which are described in more detail below. For the purpose of these examples, various PSAs were prepared which differed in respect of the added aluminum oxide particles. As well as having a different amount of aluminum oxide in the alpha modification, the PSAs also differed from one another in respect of the geometry of the particles employed, such as in terms of their average particle sizes, for instance. The polymer compositions of the PSAs were either alkyl acrylates (type A) in which one component contained hydroxyl groups, or unsubstituted alkyl acrylate compositions (type B).

The properties of these exemplarily prepared, highly cohesive, thermally conducting, pressure-sensitive adhesives were investigated according to the following techniques:

The specific surface area of different aluminum oxide particles was determined by a variant of the BET method, as part of which the adsorption of nitrogen to a sample was determined in accordance with ISO 8008.

The average particle size of the aluminum oxides was determined by static laser light scattering on samples dispersed ultrasonically in water (instrument: Malvern Instruments Mastersizer 2000), evaluation taking place in accordance with the Fraunhofer model.

The thermal conductivity of the PSAs with the aluminum oxide particles was determined by a method in accordance with ISO draft 22007-2 (test specimen thickness: 10 mm on both sides of the sheetlike heating element).

The electrical breakdown resistance of the pressure-sensitive adhesive sheetlike elements obtained with the PSAs was determined in accordance with VDE 0100.

The bond strength of pressure-sensitively adhesive sheetlike elements with PSAs in a thickness of 200 μm was determined in a peel test at an angle of 90° and with a peel speed of 300 mm/min in accordance with PSTC 1 (corresponding to ASTM D 3330-04/ISO 29862:2007). All measurements were carried out at room temperature (23° C.) under established conditions (at 50% relative humidity). The peel test was carried out exemplarily with a single sample, the bond strength being determined after a bonding time/aging period of two weeks.

The PSAs were each prepared from an acrylate polymer composition and aluminum oxide particles. Some of these PSAs contained a polymer composition which included, as copolymers, acrylic acid and hydroxyethyl methacrylate (identified here as “type A”), while the remaining PSAs did not contain hydroxyethyl methacrylate (identified here as “type B”). The PSA of type A used was a PSA comprising an acrylate polymer composition whose comonomers were 45% by weight ethylhexyl acrylate, 45% by weight butyl acrylate, 8% by weight methyl acrylate, 1% by weight hydroxyethyl methacrylate, and 1% by weight acrylic acid. The PSA of type B used was a PSA comprising an acrylate polymer composition whose constituents were alkyl acrylates that were not further substituted by hydroxyl groups (“unsubstituted alkyl acrylates”, containing no hydroxyethyl methacrylate). The comonomers in this polymer composition were 45% by weight ethylhexyl acrylate, 45% by weight butyl acrylate, 5% by weight methyl acrylate, and 5% by weight acrylic acid.

Aluminum oxide particles from various manufacturers were used, in order to ensure that the measurement results are independent of the particular method in which the particles were produced.

For preparing the acrylate polymer composition, the individual comonomers were polymerized in a manner known to the skilled person, in a mixture of benzine and acetone as solvent. The solvent was subsequently removed carefully from the resultant acrylate polymer composition, using a devolatilizing extruder, giving an overall solvent content of less than 1% by weight.

For preparing a highly cohesive, thermally conducting PSA, the acrylate polymer composition obtained above was melted and the respective aluminum oxide particles were incorporated into the melt in a laboratory kneader from Haake at a temperature of 100° C. The mass of the aluminum oxide particles was selected in each case such that the aluminum oxide particles account for 40% by volume of the blended PSA.

For producing the thermally conducting, pressure-sensitively adhesive sheetlike elements, the PSA obtained above was pressed to films with a thickness of 200 μm in a vacuum press at a temperature of 150° C. To produce the 10 mm sample thickness required for the measurement of the thermal conductivity, 50 of these carrier-free sheetlike elements were laminated on top of one another.

For the purpose of illustrating the effect which can be achieved by using the inventive PSA, only one experimental series is shown by way of example, for PSAs with aluminum oxide particles as thermally conducting auxiliary, these PSAs differing in respect of the specific structure and morphology of the aluminum oxide particles. It is noted that similar results were obtained when other polymers were used, as well.

TABLE 1

| | | | | | |
|---|---|---|---|---|---|
| | | α | | | |
| | | content | | Particle | Thermal |
| Sample | Polymer | [% by | BET | size D50 | conductivity |
| No. | type | weight] | [m²/g] | [μm] | [W/mK] |

Inventive Examples:

| | | | | | |
|---|---|---|---|---|---|
| 1 | A | 96 | 5 | 1.6 | 0.7 |
| 2 | A | 98 | 0.8 | 70 | 1.2 |
| 3 | A | 98 | 1 | 4.16 | 0.99 |
| 4 | A | 98 | 1 | 5.43 | 0.95 |
| 5 | A | 98 | 1.5 | 2.68 | 0.69 |
| 6 | A | 98 | 2 | 13.81 | 0.81 |
| 7 | A | 98 | 4.1 | 1.7 | 0.74 |
| 8 | A | 98 | 8 | 0.7 | 0.74 |
| 9 | B | 98 | 0.8 | 70 | 1.13 |

Comparative Examples:

| | | | | | |
|---|---|---|---|---|---|
| 10 | A | 95 | 9 | 3 | (gelling) |
| 11 | B | 95 | 9 | 3 | (gelling) |
| 12 | A | >70 | 10 | 3 | (gelling) |
| 13 | A | <2 | 150 | 6 | (gelling) |

This table, in addition to the sample number for identifying the samples (samples 1-9 as inventive examples and samples 10-13 as comparative examples), lists the mass-related amount of alpha-aluminum oxide in the aluminum oxide (a content), the mass-related specific surface area of the aluminum oxide particles (BET), the average particle size of the aluminum oxide (as D50 value), and the thermal conductivity of the resulting PSAs.

The nine inventive PSAs 1-9 possessed thermal conductivities from a range from 0.7 W/mK to 1.2 W/mK. For all of the inventive samples the amount of alpha-aluminum oxide was greater than 95% by weight. The viscosity of all of the blended PSAs was sufficiently high for them to be considered highly viscous; for example, the viscosity of PSA 3 was found to be 14 000 Pa*s (10 rad/s; 110° C.). Moreover, the samples could all be blended in a compounder without problems, and then pressed to a bubble-free adhesive film.

Furthermore, four non-inventive, comparative examples were prepared (samples 10-13) in which the amount of alpha-aluminum oxide was 95% by weight or less. In contrast to the inventive examples, there was in this case severe gelling of the PSAs even while still in the compounder. Under the press, therefore, the samples could no longer be shaped to form thermally conducting sheetlike elements, and so with these systems it was not possible to carry out any thermal conductivity measurements.

When the comparative examples with polymers with hydroxyethyl methacrylate as comonomer (type A; samples 10, 12 and 13) are compared with the comparative example with polymers without hydroxyethyl methacrylate as comonomer (type B; sample 11), it is evident that the problem of gelling occurs not only for PSAs with polymer compositions comprising hydroxyl groups, but may also occur with adhesives comprising acrylates that only have acid groups. With both systems, caking of the PSAs during blending in the melt was avoided by employing the teaching according to the invention.

The experiments therefore demonstrate the practical advantages which arise from the use of aluminum oxide with more than 95% by weight of alpha-aluminum oxide for acrylate-based PSAs.

Additionally, the bond strength on different bond substrates was determined for a noncrosslinked PSA after a bonding time of 14 days, specifically for sample 3. On a polar steel substrate, the bond strength thus determined was 18.1 N/cm; on a polyimide substrate it was 8.5 N/cm, and on a nonpolar polyethylene substrate it was still 0.75 N/cm. The results of the bond strength measurements demonstrate that the exemplarily selected PSA exhibits sufficiently good pressure-sensitive adhesive behavior and is therefore suitable for producing a pressure-sensitively adhesive, thermally conducting sheetlike element.

The test for electrical breakdown resistance in accordance with VDE 0100 was likewise passed by all of the inventive samples. From this it is apparent that the PSAs of the invention are electrically nonconductive and can therefore also be used where there is a requirement for electrical insulation of components joined in a thermally conducting manner, such as in electronic devices, for instance.

The experiments therefore demonstrate the outstanding suitability of the highly cohesive, thermally conducting, pressure-sensitive adhesives of the invention, and also of the thermally conducting sheetlike elements produced therewith, as heat transfer systems.

1. A cohesive, thermally conducting, pressure-sensitive adhesive comprising a polymer composition and aluminum particles, wherein
the polymer composition is an at least substantially solvent-free composition of an acrylate polymer,
and
the aluminum oxide particles are composed of more than 95% by weight of alpha-aluminum oxide.

2. The pressure-sensitive adhesive of claim 1, wherein said acrylate polymer comprises monomer units having free acid groups and/or free hydroxyl groups.

3. The pressure-sensitive adhesive of claim 1 wherein said-polymer composition comprises at least 50% by weight monomer units selected from the group consisting of acrylates, methacrylates, their esters, and derivatives thereof.

4. The pressure-sensitive adhesive of claim 1, wherein the polymer composition has a solvent content of less than 0.1% by weight.

5. The pressure-sensitive adhesive of claim 1, wherein the acrylate polymer has an average molecular mass M_{w} of at least 500 000 g/mol.

6. The pressure-sensitive adhesive of claim 1, wherein the aluminum oxide particles are composed of 97% by weight or more of alpha-aluminum oxide.

7. The pressure-sensitive adhesive of claim 1, wherein the aluminum oxide particles have a mass-based specific surface area of not more than 1.3 m²/g.

8. The pressure-sensitive adhesive of claim 1, wherein the aluminum oxide particles have an average diameter in the range of from 2 μm to 500 μm.

9. The pressure-sensitive adhesive of claim 1, wherein the aluminum oxide particles are present fraction in an amount of at least 20% by weight and not more than 90% by weight, based on the total mass of the pressure-sensitive adhesive.

10. The pressure-sensitive adhesive of claim 1 obtained by a process in which
the at least substantially solvent-free polymer composition is softened thermally without addition of solvent,
the aluminum oxide particles are added to the softened polymer composition, and
the softened polymer composition and the aluminum oxide particles are combined with one another mechanically.

11. A process for preparing a highly cohesive, thermally conducting, pressure-sensitive adhesive, in which
an at least substantially solvent-free polymer composition comprising a high molecular mass, acrylate-based base polymer is softened thermally without addition of solvent,
aluminum oxide particles whose fraction of alpha-aluminum oxide is more than 95% by weight are added to the softened polymer composition, and
the softened polymer composition and the aluminum oxide particles are combined with one another mechanically.

12. (canceled)

13. A thermally conducting sheetlike element comprising the pressure-sensitive adhesive of claim 1.

14. (canceled)

15. A method for conducting heat within an electronic device, which comprises conducing said heat through a pressure-sensitive adhesive of claim 1.
